(19) United States
(12) Patent Application Publication
(10) Pub. No.: US 2021/0138967 A1
(43) Pub. Date: May 13, 2021

(54) TAILGATE ENTERTAINMENT CENTER

(71) Applicants: Craig Lenart, Chardon, OH (US); Jeff Guritza, Brecksville, OH (US)

(72) Inventors: Craig Lenart, Chardon, OH (US); Jeff Guritza, Brecksville, OH (US)

(21) Appl. No.: 17/090,977

(22) Filed: Nov. 6, 2020

Related U.S. Application Data
(60) Provisional application No. 62/933,274, filed on Nov. 8, 2019.

(51) Int. Cl. B60R 9/06; B60R 11/02; B60N 3/10; B60N 3/16; B60N 3/00

(52) U.S. Cl. CPC B60R 9/065; B60R 11/0217; B60R 2011/0085; B60N 3/16; B60N 3/001; B60N 3/104

(57) ABSTRACT

A tailgate entertainment center is provided for the storage and transportation of tailgating component modules to a sporting event. The tailgating center is preferably embodied in a vehicle mountable rigid frame support structure with outer shell enclosure for housing audio visual equipment, food storage and preparation, tables, chairs, and canopy tent. A power supply unit, such as a lithium ion battery, and propane tank may be provided for the operation of tailgating module components. The tailgating center may be built to order by the sports fan user via a desktop or mobile device website, and personalized for professional sports team colors and logos. A preferred embodiment of the tailgating entertainment center may be provided as a rigid support frame structure housing an LED TV, Bluetooth speaker, portable stove, electric fan and propane heating element.

### BACKGROUND

In the National Football League (NFL), there are sixteen regular season games for each team. The schedule for those sixteen games is determined by a formula whereby, each team plays the other three teams in its division twice, once at home and once on the road. Each team plays each of the four teams from another division within its conference, two of the games are at home, and two are away. Each team plays once against a team from the remaining two divisions, one game at home, and one away. And also, each team plays once against the four teams in a division from the other conference, with two games at home, and two on the road. In college football, NCAA Division 1 teams typically play twelve games during the season, with most games on Saturdays. Highschool football teams usually play between eight to ten games in a season, with the majority being played on Friday nights. If a die hard football fan were to attend all of the regular season games of his or her NFL team, college football team, and local high school squad, there would be many opportunities for pre-game socializing or tailgating, not counting any additional games for playoffs, bowl games, state championships, conference championships or Superbowl games.

Attending football games at home and on the road is best enjoyed with a tailgate party with other like minded football fans before the football game. A tailgate party typically involves a group of football fans setting up an area near their parked vehicle whereby the football fans may consume alcoholic beverages, prepare food, play music, compete in lawn games, relax with friends, socialize with other football fans, and get ready for the big game. Tailgate parties also provide fans with the opportunity to build community support and raise money for the local teams. With most tailgate parties lasting a few hours and located in parking lots near football stadiums, there is a need to quickly and reliably transport, set-up and deploy tables, chairs, tents, food preparation equipment, audio visual equipment, and other recreational gear at the tailgate location, and with the capability to rapidly clean-up and remove the equipment when the game or party is over. Therefore, there is a need for a tailgate entertainment center.

### SUMMARY

A preferred embodiment of the tailgate entertainment center provides for a vehicle trailer hitch mountable unit with a rigid frame and enclosure for transporting, storing, and deploying audio visual equipment, such as a flat panel multi-media display, monitor or LED TV, a soundsystem, or bluetooth speaker system, seating, chairs, bar stools, table, food storage and food preparation equipment, an overhead shade structure, or tent, protection from weather (i.e., sun, wind, rain, etc.) and climate control devices, such as air circulating fans, air conditioning, and means for heating or cooling the persons tailgating.

A preferred embodiment of the tailgate entertainment center provides for a rigid frame and subframe structure which is mountable to a vehicle hitch. The tailgate entertainment center modules (i.e., audio visual equipment, food storage and preparation, table, seating, and tent or shade structure) are secured and storable on the rigid frame and subframe for transport and deployment. Preferably, an enclosure is provided to secure and protect the tailgate entertainment center modules during transportation and storage on the frame and subframe. To secure and transport the audio visual equipment and other modules, a preferred embodiment of the tailgating center provides lashing straps, ratcheting straps, storage compartments, lockboxes, rigid or flexible plastic or nylon coverings and outer shell.

A preferred embodiment of the tailgate entertainment center provides an electrical power supply unit for powering the audio visual equipment, food storage and preparation, and climate control devices. A preferred embodiment of the power supply may be a lithium ion battery with DC voltage output and inverter unit for AC power output. Alternatively, a generator and fuel storage tank may be provided for supplemental electrical power supply and capacity. Additionally, the tailgating center may provide a propane or natural gas powered heating unit. Food preparation equipment, may preferably include an electric range, stove top, hot plate, crock-pot, or propane or natural gas powered grill or stove. Food storage equipment may preferably include a refrigeration unit, or insulated ice chest or cooler.

In preferred embodiment the tailgate entertainment center may be designed and built by the user to include a set of desirable modules, storage, and options. Preferably, the user may build and price to order the tailgating center on a desktop or mobile device with user-specific features. For example, the user may build and select a hitch mountable frame for a certain vehicle type, and include storage and mounting equipment for a 50 inch LED TV, 100 Watt Bluetooth speaker, propane stove with multiple burners, and storage for a foldable table, chairs, and canopy tent. The user then preferably orders the tailgate entertainment center, with user-specific features, from a desktop or mobile device. Additionally, the user may personalize the tailgating center with favorite professional sports team logos and colors.

### DRAWINGS

FIG. 1 is a view of the tailgate entertainment center and module components including a flat panel display or LED TV, propane stove with burners, heating elements, and electric fan. The modules are mounted to the tailgate center rigid frame which is preferably embodied in a steel or aluminum subframe structure. The module components and frame are enclosed in an outer shell or enclosure which provides storage and protection during transport. The tailgate entertainment center is preferably mountable to a vehicle trailer hitch.

FIG. 2 is a view of the tailgate entertainment center and rigid frame and subframe structure which supports the outer shell enclosure and module components. A propane stove with burners is deployed and adjustable with a swing-arm support structure. The outer shell enclosure protects the flat panel display or LED TV, electric fan, and heating elements.

FIG. 3 is a view of the tailgate entertainment center and propane stove and heating element as supported by the rigid subframe structure. The outer shell enclosure and module components are mounted and supported by the rigid frame structure. A propane tank and power supply unit are mounted on the frame.

FIG. 4 is a view of the tailgate entertainment center and module components as supported and mounted to the rigid subframe structure. The module components are housed and protected by the outer shell enclosure.

FIG. 5 is a view of the tailgate entertainment center and module components as supported and mounted to the rigid subframe structure. The module components are housed and protected by the outer shell enclosure.

FIG. 6 is a view of the tailgate entertainment center and module components as supported and mounted to the rigid subframe structure. The module components are housed and protected by the outer shell enclosure.

FIG. 7 is a view of the tailgate entertainment center and module components as supported and mounted to the rigid subframe structure. The module components are housed and protected by the outer shell enclosure.

FIG. 8 is a view of the tailgate entertainment center and module components as supported and mounted to the rigid subframe structure. The module components are housed and protected by the outer shell enclosure.

FIG. 9 is a view of the tailgate entertainment center and module components as supported and mounted to the rigid subframe structure. The module components are housed and protected by the outer shell enclosure.

### DETAILED DESCRIPTION

A preferred embodiment of the tailgate entertainment center is a vehicle mountable structure for storing and transporting module components for use during a tailgating party at a location near sporting events, music festivals, and outdoor gatherings. The tailgate center preferred use case is for football or other sporting fans that wish to socialize and gather in the parking lot near the stadium before a game. Therefore, the tailgating center provides for the transportation and storage of module components, such as audio visual equipment, food preparation and storage, tables, chairs, and a tent, canopy or other shade/weather protective structure. The tailgating center is preferably vehicle mountable and provides for the storage and transportation of the module components. The tailgating center additionally provides power supply units and fuel storage for the operation of module components, such as an LED TV, Bluetooth speaker, and propane stove, electric fan, or heating element. Tailgating equipment such as foldable tables, chairs, and canopy tent may be stored and transported inside the protective outer shell enclosure.

A preferred embodiment of the tailgating entertainment center is a unit for transporting and storing a user-defined set of component modules for use in socializing with sports fans and friends at an outdoor gathering near a sporting event or stadium. The user may preferably build and price the tailgating center on a desktop computer or mobile device by connecting with an Internet based platform or website. The user may select and build out customizable tailgating component modules for the user's specific use-case or application. For example, the user may interact with the tailgating entertainment center website and provide the year make and model of the intended vehicle. The user will then be presented with a number of options for mounting the tailgating center to the specific vehicle. A preferred mounting location may be the vehicle rear trailer hitch. Other locations for mounting may include the rear lift gate area, hatchback, truck trailer lift gate and bed, rooftop rack mountable, or other configuration.

A preferred embodiment of the tailgating entertainment center may provide for the user to select a user-defined set of component modules for tailgating and entertainment purposes. The user may preferably select audio visual devices, such as a 50 inch LED TV or flat panel display, and a 100 watt Bluetooth speaker. The LED TV may be integrated with a mobile satellite or broadband network receiver component device for receiving live broadcasts or on-demand streaming of NFL games and other sporting events for display on the flat panel display monitor. The Bluetooth speaker and other audio equipment may provide music entertainment services and streaming via wireless connectivity with the user's mobile device. The audio visual equipment may be preferably powered by a power supply unit such as a lithium ion battery with a sufficient capacity (i.e., 1.0 kWh, 50 Ah, 12 VDC, and 120 VAC inverter output) and with 4-5 hours duration of discharge at rated power for the tailgating component modules.

A preferred embodiment of the tailgating entertainment center may provide the user with a set of user-defined food storage and preparation equipment devices. The tailgating center may provide and house a propane gas grill or stove with multiple burners and cooking surfaces. The grill or stove may be supported and mounted to the tailgating center rigid subframe and be deployable and adjustable to fold or roll-out of the outer shell enclosure during tailgating. The user may build out the tailgating center with additional food preparation surfaces and devices as needed, such as a crock-pot, hot plate, oven, deep fryer, refrigeration storage, and ice chest for storage of food and beverages. The food preparation equipment and devices may be preferably powered by a power supply unit such as a lithium ion battery, propane gas tank, or electrical generator with fuel storage.

A preferred embodiment of the tailgating entertainment center may provide the user with a set of user-defined foldable tables, chairs, and pop-up tents, canopies, shade structures, or other weather protection from sun, wind, and rain. The tailgating center may preferably provide storage and rapid deployment of a portable folding picnic table with a number of folding chairs or bar stools for the user and other guests or sports fans. The user may build out the tailgating center to provide storage for a 10-ft. by 10-ft. pop-up canopy shade structure, with side panels for protection from wind or rain. The user may preferably customize the tailgating center with climate control devices such as a number of electric fans for hot weather. For cold weather, the user may build the tailgating center with propane gas powered heating elements, such as a propane tank top heater, or a 50,000 BTU portable overhead umbrella propane patio heater.

For additional entertainment on game day, the user may build the tailgate entertainment center to include storage and housing for lawn games. The tailgating center may preferably provide for transportation and deployment of Cornhole boards and bean bags, bocce ball set, footballs, frisbees, etc. Additionally, the tailgating entertainment center may be personalizable to the user's favorite professional sports team logos and colors.

FIG. 1 is a preferred embodiment of the tailgate entertainment center for transporting and housing module components to a sporting event or outdoor social gathering. The module components are mounted to the vehicle mountable rigid support frame structure with outer shell enclosure 10. Food preparation is preferably provided with the propane stove 20 mounted to adjustable swing-arm 30 and integrated with the rigid support frame 40. Audio visual entertainment is provided with an LED flat panel display 50. Propane gas heating elements are provided at 60 and 70. Electric cooling fan is provided at 80. The outer shell enclosure and module components are mounted to the rigid support frame 90.

FIG. 2 is a preferred embodiment of the tailgate entertainment center for the storage and transportation of component modules to a sporting event. The component modules are housed inside the outer shell enclosure 10. Food preparation is provided with the propane stove 20 which is mounted to adjustable swing-arm 30 and integrated with rigid support frame 40. The stove 20 is shown in the deployed position with the adjustable swing-arm 30 extended from the support frame 40. The stove 20 and swing-arm 30 are secured in position preferably with a detent quick-release pin or screw. An LED TV or flat panel display 50 provides live game day broadcasts of sporting events. Heat for tailgating fans is provided by propane gas heating elements 60 and 70. Module components and the outer shell enclosure are mounted to rigid support frame 90.

FIG. 3 is a preferred embodiment of the tailgate entertainment center for storage and transportation of component modules via the vehicle mountable support structure. The outer shell enclosure 10 protects the modules during transport and storage. Food preparation is provided with propane gas stove 20. The stove 20 is shown in the deployed position with the adjustable swing-arm extended from the support frame. The stove 20 and swing-arm 30 are secured in position preferably with a detent quick-release pin or screw. Heat during cold weather is provided with propane gas heating element 60. A power supply unit 140 provides electrical power for the module components. Propane gas tank 130 provides additional fuel for component modules, stove, and heating elements. The rigid support frame 110 is mountable to a vehicle hitch for transportation. The lower horizontal support member 120, vertical support member 100, rear plate 150, and upper horizontal support member 90, integrate the tailgate entertainment center rigid subframe, outer shell, and module components. Mounting bracket 160 supports the heating element component module 60.

FIG. 4 is a preferred embodiment of the tailgate entertainment center for storage and transportation of component modules via the vehicle mountable support structure. The outer shell enclosure 10 protects component modules during transport and storage. Food preparation is provided with propane stove 20. The stove 20 is shown in the deployed position with the adjustable swing-arm extended from the support frame. The stove 20 and swing-arm 30 are secured in position preferably with a detent quick-release pin or screw. Propane gas fuel tank 130 provides fuel for the stove 20 and heating elements 60 and 70. Electric fan 80 provides cooling and air flow for tailgating guests. LED TV or flat panel display 50 provides entertainment and live broadcasts of sporting events. Rigid support frame and subframe 90 provides mounting of component modules to vehicle.

FIG. 5 is a preferred embodiment of the tailgate entertainment center for storage and transportation of components modules to sporting events. Outer shell enclosure 10 houses and protects component modules during transport and storage. Food preparation is provided with propane stove 20 which is mounted to adjustable swing-arm 40 and rigid support frame 40. The stove 20 is shown in the deployed position with the adjustable swing-arm extended from the support frame. The stove 20 and swing-arm 30 are secured in position preferably with a detent quick-release pin or screw. LED flat panel display 50 provides entertainment and live broadcast of sporting events. Heating elements 60 and 70 provide warmth for sports fans and guests during cold weather. Electric cooling fan 80 provides cooling during hot weather. Rigid support frame members 110, 120, 125 provide mounting support for component modules to vehicle.

FIG. 6 is a preferred embodiment of the tailgate entertainment center for storage and transportation of component modules to sporting events. Outer shell enclosure 10 houses and protects component modules during transport and storage. Food preparation is provided with propane stove 20. Propane gas tank 130 provides fuel for stove 20 and heating element 60. The rigid support frame 110 is mountable to vehicle hitch for transport. Lower horizontal support member 120, vertical support member 100, rear plate 150, and upper horizontal support member 90, integrate the tailgate entertainment center rigid subframe, outer shell, and module components. Mounting bracket 160 supports the heating element component module 60. A power supply unit 140 provides electrical power for the module components.

FIG. 7 is a preferred embodiment of the tailgate entertainment center for transportation and housing of component modules to sporting events. Outer shell enclosure 10 houses and protects component modules during transport and storage. Food preparation stove unit 20, which is mounted on a moveable swing-arm, is stored inside the enclosure for transport. LED flat panel display 50 is housed in the enclosure. Heating elements 60 and 70 provide heat during cold weather conditions. Electric fan 80 provides air circulation and cooling during hot weather conditions.

FIG. 8 is a preferred embodiment of the tailgate entertainment center for transportation and housing of component modules to sporting events. Outer shell enclosure 10 houses and protects component modules during transport and storage. Foldable table unit 170 is stored inside the outer shell enclosure, at mounting brackets 175 and 180, for deployment at the tailgating site.

FIG. 9 is a preferred embodiment of the tailgate entertainment center for transportation and housing of component modules to sporting events. The outer shell enclosure 10 and back cover 200 houses and protect component modules during transport and storage. The upper horizontal support member 90 and rigid support frame 110 is mountable to a vehicle hitch for transport. A power supply unit 140 with cover 145 provides electrical power for the module components. Propane gas tank 130 provides additional fuel for component modules, stove, and heating elements.

1. A tailgate entertainment center, comprising:
a vehicle mountable rigid support frame structure with an outer shell enclosure;
at least one of each of the following integrated component modules: audio visual entertainment device, food storage container, food preparation device, table, chair, shade structure, climate control device, and backyard lawn game; and
a power supply unit;
wherein, the integrated component modules and power supply unit are secured inside the outer shell enclosure; wherein, the tailgate entertainment center and integrated component modules are stored, transported, and rapidly deployed on location at sporting events; and wherein, the entertainment center itself may be personalized with professional sports team logos.

2. The tailgate entertainment center of claim 1, wherein at least one of the integrated component modules is mountable to an adjustable swing arm structure, compactly and securely stored within the outer shell enclosure during transport, swung out to be deployed and utilized on location at the sporting event, and retractable to be stored after the event is over.

3. The tailgate entertainment center of claim 1, wherein the vehicle mountable rigid support frame structure has a mounting location and is customizable by a user-defined set of parameters such as vehicle year, make and model, and location such as rear trailer hitch, lift gate, hatchback, truck trailer lift gate or bed, or rooftop rack mounting.

4. The tailgate entertainment center of claim 1, wherein the integrated component modules are customizable by a user-defined set of configurations such as whether to include and the parameters of the following modules: a flat panel display, the display screen size, wireless speaker and wattage, lithium ion battery power supply and battery life, propane gas stove and number of burners, ice chest cooler or refrigerator size, canopy shade structure length and width, propane heater and BTUs, electric cooling fan, folding table size, number of chairs, and the user's preferred sports team logo branded football or lawn game.

5. The tailgate entertainment center of claim 1, wherein the food preparation device comprises a propane stove mounted to an adjustable swing-arm integrated with the rigid support frame structure.

6. The tailgate entertainment center of claim 1, wherein the climate control device comprises a propane gas heating element and a plurality of electric fans for air circulation.

7. The tailgate entertainment center of claim 1, wherein the backyard lawn game comprises bean bags, bocce ball, football, or frisbee.
